(19) United States
(12) Patent Application Publication
(10) Pub. No.: US 2014/0038128 A1
(43) Pub. Date: Feb. 6, 2014

(54) DENTAL PIEZOELECTRIC ULTRASONIC MAGNETIC SWITCHING SCALER HANDPIECE AND METHOD OF USE

(71) Applicant: Jerry T. Huang, Diamond Bar, CA (US)

(72) Inventor: Jerry T. Huang, Diamond Bar, CA (US)

(21) Appl. No.: 13/567,765

(22) Filed: Aug. 6, 2012

(51) Int. Cl. A61C 17/12

(52) U.S. Cl. 433/99; 433/216

(57) ABSTRACT

A dental piezoelectric ultrasonic magnetic switching scaler handpiece is activated by magnetic means. The dental piezoelectric scaler handpiece includes a housing that contains a fixed magnet and a magnetically activated switch. An activation magnet longitudinally slides along the outside of the housing from a de-energized position to an energized position. The activation magnet is biased to the de-energized position by the fixed magnet. When a user moves the activation magnet away from the fixed magnet and toward the magnetically activated switch, the magnetic field of the activation magnet activates the magnetically activated switch and turns the dental scaler handpiece on.

### TECHNICAL FIELD

The present invention pertains generally to dental tools, and more particularly to a dental piezoelectric ultrasonic magnetic switching scaler handpiece that is activated by an activation magnet that externally surrounds the handpiece housing. The activation magnet is positionable to de-energized and energized positions along the longitudinal axis of the handpiece housing.

### BACKGROUND OF THE INVENTION

Power driven dental tools are well known in the art. One such tool is an ultrasonic dental scaler that has a tip that vibrates at a high frequency in order to remove both plaque and calculus from teeth. Two types are available for producing the ultrasonic vibration: magnetostrictive and piezoelectric. The magnetostrictive type creates a pulsing magnetic field that is applied to a metal stack that flexes to move the tip. The piezoelectric type uses pulsing voltage that is applied to ceramic crystal that moves the tip.

Ultrasonic scalers are typically controlled through a foot control pedal system that activates or deactivates the handpiece unit. Current models of ultrasonic scalers require the use of the foot switch to control handpiece operation. When the user presses the foot pedal, the ultrasonic scaler is switched on. When the user removes his/her foot from the foot pedal, the ultrasonic scaler is turned off.

Ultrasonic scalers with hand controlled rather than foot controlled switches have been developed. However, hand controlled switches are not popular due to the limitations of ergonomics, the inability to be sterilized (autoclaved), and controllability. For example, during normal operation of a typical ultrasonic scaling unit, it is necessary for the dentist or dental professional to have the ability to rotate the handpiece in a manner that allows full access to the oral cavity. A hand activated switch has the disadvantage that the switch is not accessible at all times as the handpiece is being manipulated during the course of a dental procedure.

Foot controlled switches also have drawbacks in a clinical setting. A foot switch occupies space on the floor of a dental office that may be already occupied by several other related dental equipment units such as intraoral camera foot controls, laser foot controls, high speed and low speed handpiece foot controls, etc. A clinic floor with several competing devices for floor space is not an efficient approach to efficient clinic operation. Moreover, a foot switch occupies a fixed location and thus must be manually placed in an ergonomic position depending on the user's left foot or right foot preference. Also, the foot switch must be manually moved whenever the dental chair or the dentist changes location. Foot pedals can also interfere with general cleaning routines of the dental office floor, as the foot pedals must be moved off the office floor to effect cleaning. Further, foot switches require a cable connected from the dental tool such as a scaler to the foot switch. The cable can potentially tangle with the user during normal clinical procedures. The constant risk of wire damage to the foot switch cable can make foot switch pedals a solution that is not optimal. Even wireless foot switches have problems with interference that make them not a viable option in the marketplace. Issues such as floor placement and positioning are still not resolved with wireless foot pedals.

Further, dental ultrasonic scaler handpieces are required to be autoclaved after every patient treatment procedure. Autoclaving involves high pressure and temperatures in order to achieve hygienic standards set by law. A hermetically sealed handpiece is thus required for the current design of handpiece units.

In view of the above, it would be advantageous to have a dental scaling handpiece with the following properties:

1. no need to use a hardwired or wireless foot switch;

2. 360° accessibility of the handpiece switch at any angle or position of the handpiece;

3. no interference with the ultrasonic properties of the handpiece from a cable that passes from outside through a hermetic seal into the inside;

4. no interference from the water line located inside the handpiece unit; and,

5. a handpiece that can be easily detached for autoclaving and cleaning.

### BRIEF SUMMARY OF THE INVENTION

The present invention is directed to a dental piezoelectric ultrasonic magnetic switching scaler handpiece that is magnetically controlled. it does not apply to the magnetostrictive type of handpiece because of the magnetic interference that is inherent in this type. The dental scaler handpiece is used by dentists and hygienists. The dental scaler handpiece utilizes a suspended movable activation magnet and a magnetically activated switch to turn the device on and off. The sliding activation magnet is biased to a de-energized position by a fixed magnet. When the activation magnet is physically moved to an energized position by the user, the magnetically activated switch is activated and the dental scaler handpiece is turned, on. There is no need for a foot control. The sliding external activation magnet does not require a spring return, and does not interfere with the vibration or water flow of the dental scaler handpiece. The sliding activation magnet is 360° accessible to the user regardless of the relative position of the user's hands or the angle of the handpiece, and applies equally well to both left handed and right handed users.

In an embodiment, a dental scaler handpiece includes a housing that has a longitudinal axis. A fixed magnet is disposed within the housing. A magnetically activated switch is also disposed within the housing. The magnetically activated switch is spaced apart from the fixed magnet along the longitudinal axis so that it is not activated by the fixed magnet. An external activation magnet has an aperture that is shaped and dimensioned to receive the housing. The activation magnet is positionable along the longitudinal axis (1) to a de-energized position away from the magnetically activated switch, and (2) to an energized position toward the magnetically activated switch. The fixed magnet urges the activation magnet to the de-energizing position. When the activation magnet is manually moved to the energized position, the magnetically activated switch is activated.

In accordance with another embodiment, the housing has a de-energized stop that limits movement of the activation magnet in the de-energized position, and the housing has an energized stop that limits movement of the activation magnet in the energized position.

In accordance with another embodiment, the housing has a perimeter, and the activation magnet is accessible 360° around the perimeter of the housing.

In accordance with another embodiment, the housing, the activation magnet, and the aperture are all circular.

In accordance with another embodiment, the activation magnet slides along the housing without any physical connection therebetween.

In accordance with another embodiment, the activation magnet is urged by the magnetic attraction of the fixed magnet to the de-energized position without the need for a spring member.

In accordance with another embodiment, no wires connect the activation magnet and the magnetically activated switch.

In accordance with another embodiment, the activation magnet moves along the longitudinal axis between about 2 millimeters (mm) and about 12 mm from the de-energized position to the energized position.

In accordance with another embodiment, the activation magnet moves along the longitudinal axis about 3 mm.

Other embodiments, in addition to the embodiments enumerated above, will become apparent from the following detailed description, taken in conjunction with the accompanying drawings, that illustrate, by way of example, the principles of the dental scaler handpiece and method of use.

### BRIEF DESCRIPTION OF THE DRAWINGS

FIG. 1 is a reduced exploded view of a dental piezoelectric ultrasonic magnetic switching scaler handpiece;

FIG. 2 is a side elevation view of the dental scaler handpiece in a de-energized state;

FIG. 3 is a cutaway side elevation view of the dental scaler handpiece in the de energized state;

FIG. 4 is a side elevation view of the dental scaler handpiece in an energized state;

FIG. 5 is a cutaway side elevation view of the dental scaler handpiece in the energized state;

FIG. 6 is an enlarged cross sectional view along line 6-6 of FIG. 2 showing the dental scaler handpiece in the de-energized state;

FIG. 7 is an enlarged cross sectional view along line 7-7 of FIG. 4 showing the dental scaler handpiece in the energized state;

FIG. 8 is an enlarged cross sectional view along the line 8-8 of FIG. 2;

FIG. 9 is an enlarged perspective view of a fixed magnet, an activation magnet; and a magnetically activated switch in the de-energized position;

FIG. 10 is an enlarged perspective view of the fixed magnet, the activation magnet, and the magnetically activated switch in the energized position; and,

FIG. 11 is a perspective view of the dental scaler handpiece being held by a user.

### DETAILED DESCRIPTION OF THE INVENTION

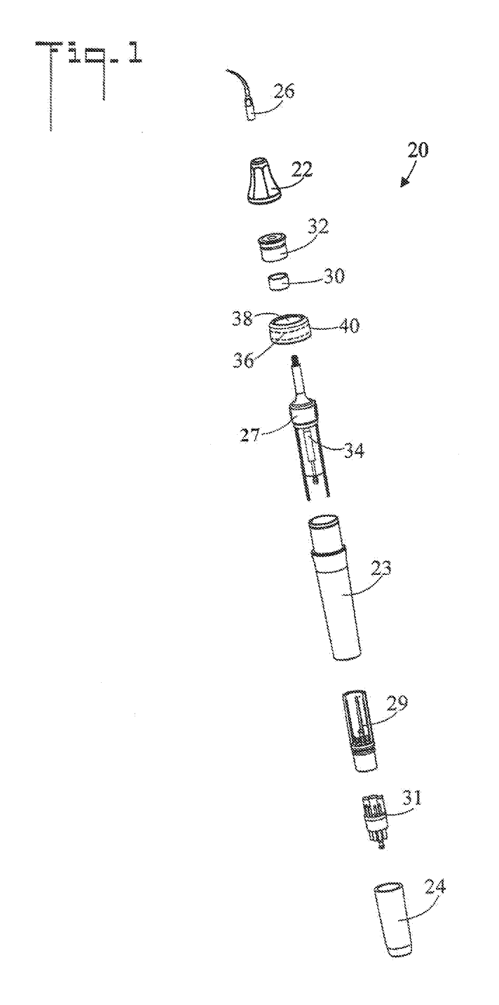

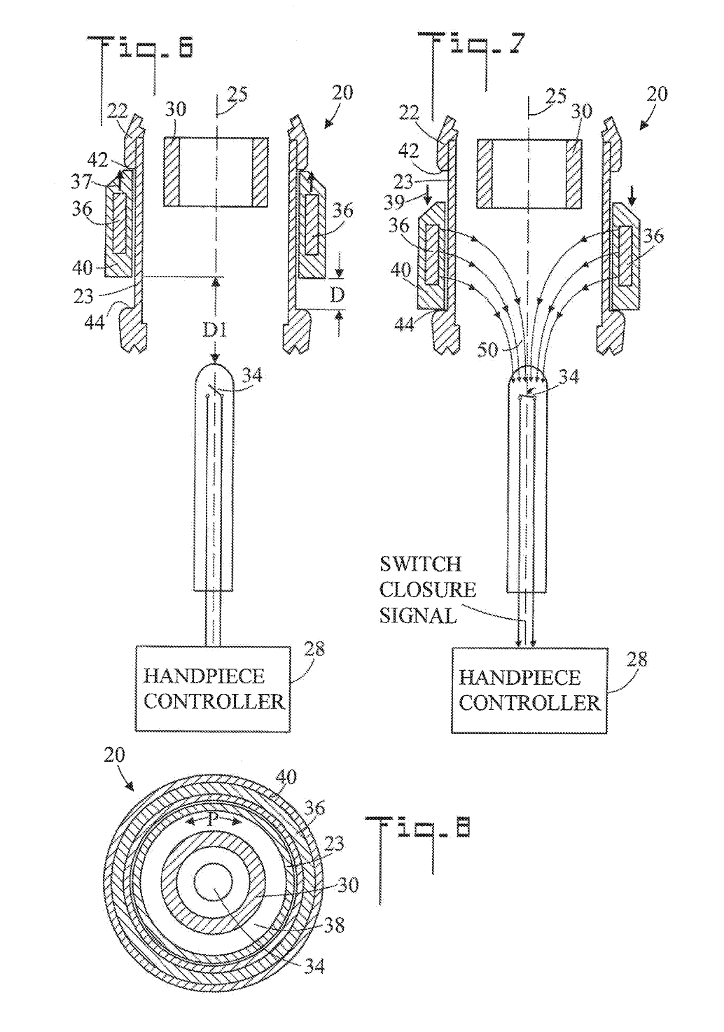

Referring initially to FIGS. 1-3, there are illustrated reduced exploded, side elevation, and cutaway side elevation views, respectively, of a dental piezoelectric ultrasonic magnetic switching scaler handpiece in a de-energized state, the dental scaler handpiece generally designated as 20. Dental scaler handpiece 20 includes a housing that has a longitudinal axis 25. In the shown embodiment, the housing comprises a front housing 22, a main housing 23, and a rear housing 24. An ultrasonic piezoelectric transducer 27 is located inside main housing 23. Front housing 22 receives a dental tool 26 that is coupled to the ultrasonic piezoelectric transducer 27. Rear housing 24 connects to an external power supply in a handpiece controller 28 (refer also to FIGS. 6 and 7). A fixed magnet 30 is disposed within the main housing 23. In the shown embodiment, fixed magnet 30 is surrounded by a fixed magnet housing 32. Magnetically activated switch 34 is spaced apart from fixed magnet 30 along longitudinal axis 25. In the shown embodiment, magnetically activated switch 34 is a reed switch such as Type No. SWR-1010 sold by Jin Zon Enterprise Co. Ltd. of Taipei, Taiwan, Republic of China.

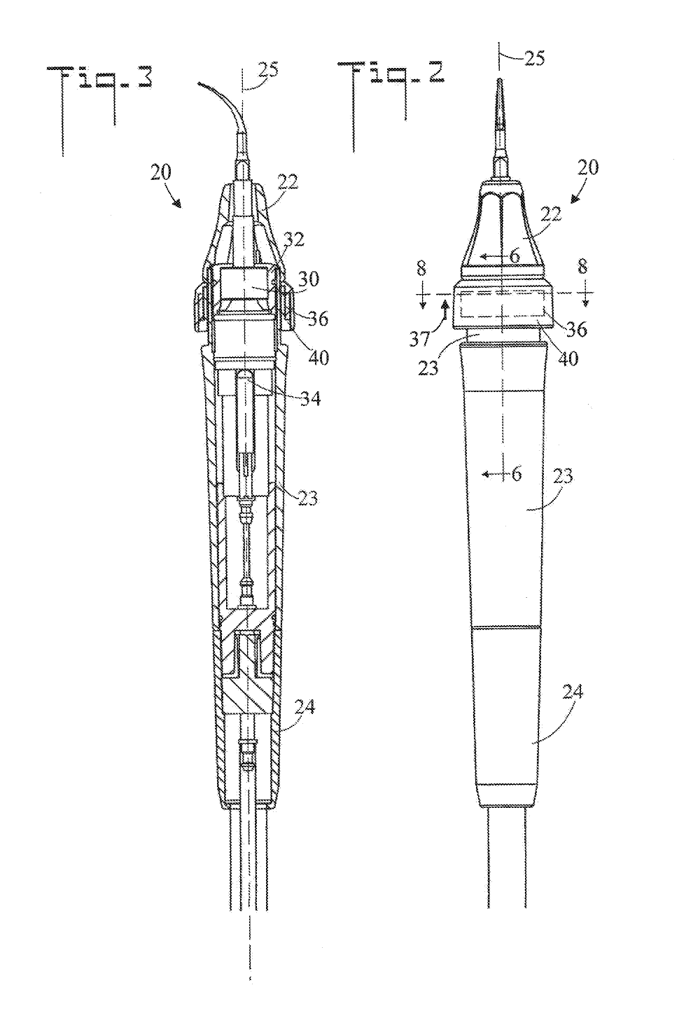

An activation magnet 36 has an aperture 38 that is shaped and dimensioned to receive the main housing 23 in the shown embodiment so that activation magnet 36 is positionable along longitudinal axis 25 (1) to a de-energized position away from magnetically activated switch 34, and (2) to an energized position toward magnetically activated switch 34 (also refer to FIGS. 6-10). in FIGS. 1 and 2, activation magnet 36 is shown in dashed lines, and is housed within an activation magnet housing 40. Activation magnet housing 40 closely receives the main housing 23, so that activation magnet housing 40 and activation magnet 36 may he manually slid along the main housing 23 from the de-energized position to the energized position. Fixed magnet 30 magnetically attracts activation magnet 36 to the de-energizing position in the direction of arrow 37 (refer also to FIG. 6). Referring also to FIG. 7, when activation magnet 36 is manually moved to the energized position, magnetically activated switch 34 is activated. That is, when activation magnet 36 is moved toward magnetically activated switch 34 in the direction of arrow 39, the magnetic field 50 of activation magnet 36 causes magnetically activated switch 34 to close, Also shown in FIG. 1 are water and electrical female connector 29 and water and electrical male connector 31.

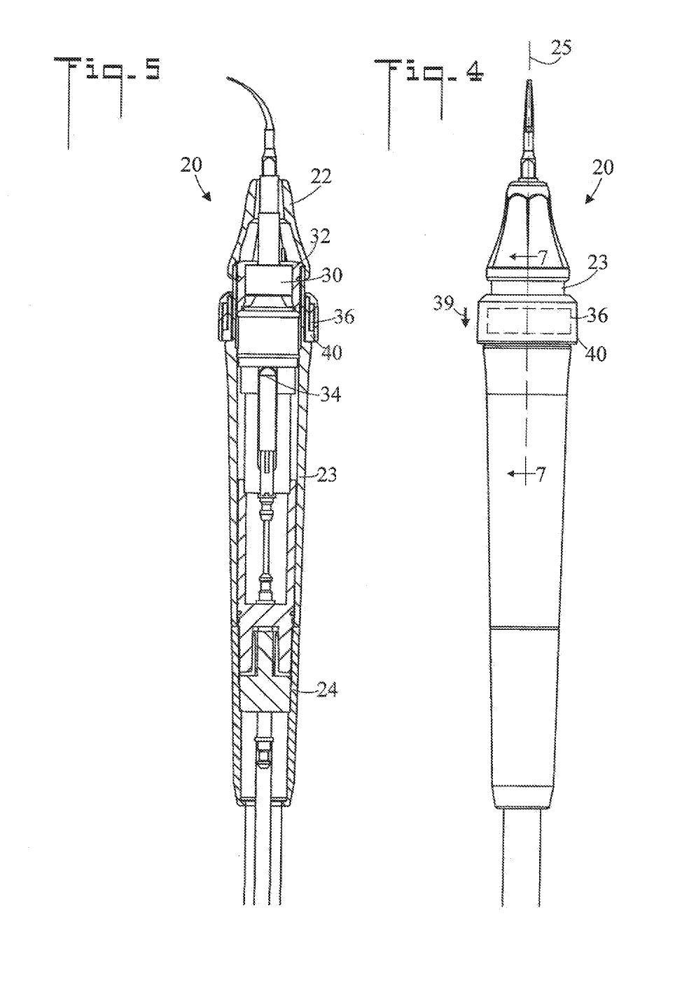

FIGS. 4 and 5 are side elevation and cutaway side elevation views, respectively, of dental scaler handpiece 20 in the energized state. Shown are front housing 22, main housing 23, rear housing 24, fixed magnet 30, magnetically activated switch 34, activation magnet 36, and activation magnet housing 40. In the shown energized position, activation magnet housing 40 and activation magnet 36 have been manually pushed in the direction of arrow 39 to the energized position. In doing so, the user must overcome the magnetic attraction between fixed magnet 30 and activation magnet 36. FIG, 6 is an enlarged cross sectional view along line 6-6 of FIG. 2 showing the dental scaler handpiece in the de-energized state. FIG. 7 is an enlarged cross sectional view along line 7-7 of FIG. 4 showing the dental sealer handpiece 20 in the energized state. It is noted that in FIG. 6, activation magnet 36 is urged in direction 37 by the magnetic attraction of magnet 30 to the de-energized position without the need for a spring member. Front housing 22 has a de-energized stop 42 or shoulder that limits movement of activation magnet 36 and activation magnet housing 40 in the de-energized position. Similarly, main housing 23 has an energized stop 44 or shoulder that limits movement of activation magnet 36 and activation magnet housing 40 in the energized position. It is noted that activation magnet 36 and activation magnet housing 40 slide along the main housing 23 without any physical connection therebetween. It is also noted that no wires connect activation magnet 36 and magnetically activated switch 34. In other words, the activation of magnetically activated switch 36 is effected only by magnetic means.

Several parameters combine to make operation of dental scaler handpiece 20 possible. The relative physical placement of fixed magnet 30, activation magnet 36, and magnetically activated switch 34 must be considered. Also important are the distance of movement of activation magnet 36 from the de-energized position to the energized position, the magnetic strengths of fixed magnet 30 and activation magnet 36, and the magnetic sensitivity of magnetically activated switch 34. These parameters must be selected so that when activation magnet 36 is in the de-energized position (FIG. 6), magnetically activated switch 34 will not energize, and when activation magnet 36 is moved to the energized position (FIG. 7), the magnetic field 50 of activation magnet 36 will cause magnetically activated switch 34 to activate or close. In the embodiment shown in FIG. 6, activation magnet 36 moves along longitudinal axis 25 a distance D that is between about 2 mm and about 12 mm from the de-energized position to the energized position. That is, activation magnet housing 40 is free to move between de-energized shoulder 42 and energized shoulder 44 a distance D. In one embodiment, distance D is about 3 mm which provides enough proximity for effective triggering of the magnetically activated switch 34 while maintaining operator comfort and control.

Magnetically activated switch 34 is electrically connected to handpiece controller 28 that is remotely located from dental scaler handpiece 20. Handpiece controller 28 receives the switch closure from magnetically activated switch 34 and uses that closure to activate dental scaler handpiece 20. In one mode of handpiece controller 28 operation, dental scaler handpiece 20 is activated when activation magnet 36 is in the energized position, and deactivated When activation magnet 36 is in the de-energized position. That is, activation magnet 36 must be held in the energized position in order for dental scaler handpiece 20 to be activated. In a second mode of handpiece controller 28 operation, dental scaler handpiece 20 is activated when activation magnet 36 is moved to the energized position and remains activated even if activation magnet 36 is released to return to the de-energized position. The dental scaler handpiece 20 is then de-activated by again moving activation magnet 36 to the energized position and releasing the activation magnet 36 which causes dental scaler handpiece 20 to de-energize. These modes of operation are programmed into handpiece controller 28 with firmware.

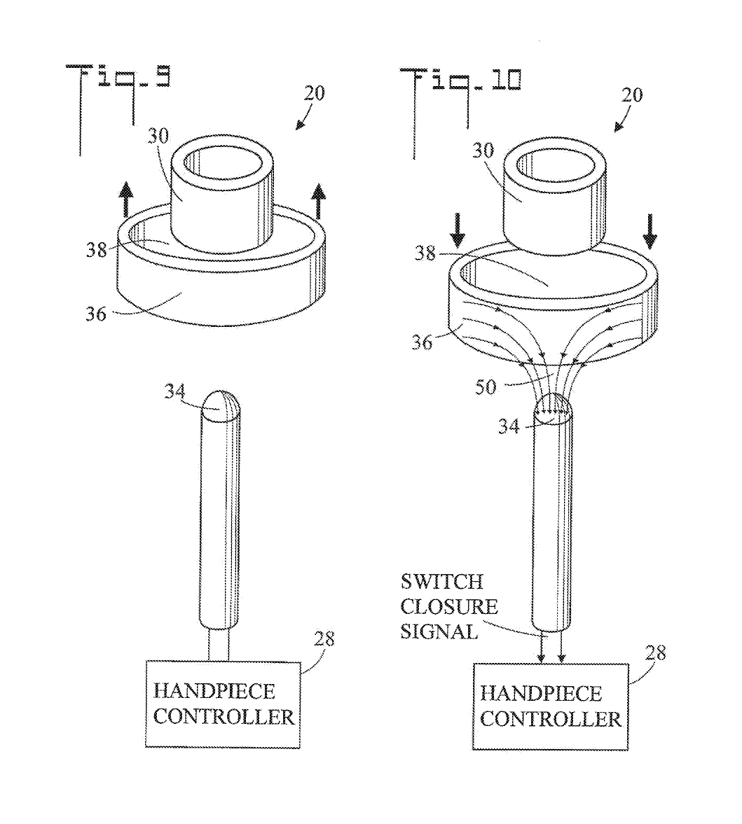

FIG. 8 is an enlarged cross sectional view along the line 8-8 of FIG. 2, showing fixed magnet 30, magnetically activated switch 34, activation magnet 36, aperture 38, activation magnet housing 40, and main housing 23. It is noted that main housing 23 has a perimeter P and that activation magnet 36 is accessible 360° around perimeter P of the housing. It is further noted that main housing 23, activation magnet 36, activation magnet housing 40, and aperture 38 are all circular.

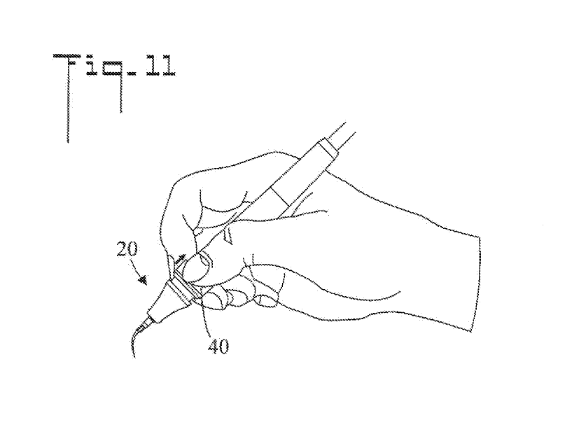

FIG. 9 is an enlarged perspective view of fixed magnet 30, activation magnet 36, and magnetically activated switch 34 in the de-energized position. FIG. 10 is an enlarged perspective view of fixed magnet 30, activation magnet 36, and magnetically activated switch 34 in the energized position. It is noted that activation magnet 36 is generally disposed between fixed magnet 30 and magnetically activated switch 34, and that in the shown embodiment, fixed magnet 30 and activation magnet 36 are ring shaped. Various types of magnets could be used for this purpose. Fixed magnet 30 is preferably a bonded neodymium, iron, boron permanent magnet having a 10.4 mm outer diameter, an 8.1 mm inner diameter, and a 3.55 mm length producing 2700 gauss. Activation magnet 36 is preferable of the same material having a 20 mm outer diameter, an 18 mm inner diameter, and a 6 mm length. producing 1400 gauss.

FIG. 11 is an enlarged perspective view of dental scaler handpiece 20 being held by a user. The user can hold. dental scaler handpiece 20 like a pencil and use the thumb and index finger as preferred digits to move activation magnet housing 40 with activation. magnet 36 away from fixed magnet 30 and toward magnetically activated switch 34 (refer to FIGS. 6 and

In terms of use, a method for a user to use a dental scaler handpiece includes (refer to FIGS. 1-11):

(a) providing a dental piezoelectric scaler handpiece 20 including;
a housing (22, 23, 24) having a longitudinal axis 25;
a fixed magnet 30 disposed within the housing;
a magnetically activated switch 34 disposed within the housing, magnetically activated switch 34 spaced apart from fixed magnet 30 along longitudinal axis 25;
an activation magnet 36 having an aperture 38 that is shaped and dimensioned to receive the housing so that activation magnet 36 is positionable along longitudinal axis 25 (1) to a de-energized position away from magnetically activated switch 34, and (2) to an energized position toward magnetically activated switch 34; and,
fixed magnet 30 urging activation magnet 36 to the de-energizing position; and,

(b) the user manually moving activation magnet 36 to the energized position, thereby causing magnetically activated switch 34 to activate.

The method further including:
in (a), the housing having a dc-energized stop 42 that limits movement of activation magnet 36 in the de-energized position, and the housing having an energized stop 44 that limits movement of activation magnet 36 in the energized position;
in (a), dc-energized stop 42 limiting movement of activation magnet 36 in the de-energized position; and,
in (b), energized stop 44 limiting movement of activation magnet 36 in the energized position.

The method further including:
in (a), the housing having a perimeter P; and,
in (b), activation magnet 36 being accessible 360° around perimeter P of the housing.

The method further including:
in (b), activation magnet 36 moving along longitudinal axis 25 between about 2 mm and about 12 mm from the de-energized position to the energized position.

The method further including:
in (a), activation magnet 36 sliding along the housing without any physical connection therebetween.

The method further including:
in (a), activation magnet 36 urged by magnetic attraction of fixed magnet 30 to the de-energized position without the need for a spring member.

The method further including:
in (a), no wires connecting activation magnet 36 and magnetically activated switch 34.

The user having a thumb and an index finger, the method further including:
in (b), the user using the thumb and the index finger to move activation magnet 36 to the energized position.

The embodiments of the dental piezoelectric ultrasonic magnetic switching scaler handpiece and method of use described herein are exemplary and numerous modifications, combinations, variations, and rearrangements can be readily envisioned to achieve an equivalent result, all of which are intended to be embraced within the scope of the appended claims. Further, nothing in the above provided discussions of the dental scaler handpiece and method should be construed as limiting the invention to a particular embodiment or combination of embodiments. The scope of the invention is defined by the appended claims.

1. A dental piezoelectric scaler handpiece, comprising:
a housing having a longitudinal axis;
a fixed magnet disposed within said housing;
a magnetically activated switch disposed within said housing, said magnetically activated switch spaced apart from said fixed magnet along said longitudinal axis;
an activation magnet having an aperture that is shaped and dimensioned to receive said housing so that said activation magnet is positionable along said longitudinal axis (1) to a de-energized position away from said magnetically activated switch, and (2) to an energized position toward said magnetically activated switch;
said fixed magnet urging said activation magnet to said de-energizing position; and,
when said activation magnet is manually moved to said energized position, said magnetically activated switch is activated.

2. The dental piezoelectric scaler handpiece according to claim 1, further including:
said housing having a de-energized stop that limits movement of said activation magnet in said de-energized position; and,
said housing having an energized stop that limits movement of said activation magnet in said energized position.

3. The dental piezoelectric scaler handpiece according to claim 1, further including;
said housing having a perimeter; and,
said activation magnet accessible 360° around said perimeter of said housing.

4. The dental piezoelectric sealer handpiece according to claim 3, further including:
said housing, said activation magnet, and said aperture all being circular.

5. The dental piezoelectric scaler handpiece according to claim 1, further including:
said activation magnet sliding along said housing without any physical connection therebetween.

6. The dental piezoelectric scaler handpiece according to claim 1, further including:
said activation magnet urged by magnetic attraction of said magnet to said de-energized position without the need for a spring member.

7. The dental piezoelectric scaler handpiece according to claim 1, further including:
no wires connecting said activation magnet and said magnetically activated switch.

8. The dental piezoelectric scaler handpiece according to claim 1, further including:
said activation magnet moving along said longitudinal axis between about 2 mm and about 12 mm from said de-energized position to said energized position.

9. The dental piezoelectric scaler handpiece according to claim 8, further including:
said activation magnet moving along said longitudinal axis about 3 mm.

10. The dental piezoelectric scaler handpiece according to claim 1, further including:
said housing having a de-energized stop that limits movement of said activation magnet in said de-energized position;
said housing having an energized stop that limits movement of said activation magnet in said energized position;
said housing having a perimeter;
said activation magnet accessible 360° around said perimeter of said housing;
said housing, said activation magnet, and said aperture all being circular;
said activation magnet moving along said longitudinal axis between about 2 mm and about 12 mm from said de-energized. position to said energized position;
said activation magnet sliding along said housing without any physical connection therebetween;
said activation magnet urged by magnetic attraction of said fixed magnet to said de-energized position without the need for a spring member; and,
no wires connecting said activation magnet and said magnetically activated switch.

11. A method for a user to use a dental piezoelectric scaler handpiece, comprising:
(a) providing a dental piezoelectric scaler handpiece including:
a housing having a longitudinal axis;
a fixed magnet disposed within said housing;
a magnetically activated switch disposed within said housing, said magnetically activated switch spaced apart from said fixed magnet along said longitudinal axis;
an activation magnet having an aperture that is shaped and dimensioned to receive said housing so that said activation magnet is positionable along said longitudinal axis (1) to a dc-energized position away from said magnetically activated switch, and (2) to an energized position toward said magnetically activated switch; and,
said magnet urging said activation magnet to said de-energizing position; and,
(b) the user manually moving said activation magnet to said energized position, thereby causing said magnetically activated switch to activate.

12. The method of claim 11, further including:
in (a), said housing having a de-energized stop that limits movement of said activation magnet in said de-energized position, and said housing having an energized stop that limits movement of said activation magnet in said energized position;
in (a), said de-energized stop limiting movement of said activation magnet in said de-energized position; and,
in (b), said energized stop limiting movement of said activation magnet in said energized position.

13. The method of claim 11, further including:
in (a), said housing having a perimeter; and,
in (b), said activation magnet accessible 360° around said perimeter of said housing.

14. The method of claim 11, further including:
in (a), said activation magnet moving along said longitudinal axis between about 2 mm and about 12 mm from said de-energized position to said energized position.

15. method of claim 11, further including:
in (a), said activation magnet sliding along said housing without any physical connection therebetween.

16. The method of claim 11, further including:
in (a), said activation magnet urged by magnetic attraction of said magnet to said de-energized position without the need for a spring member.

17. The method of claim 11, further including:
in (a), no wires connecting said activation magnet and said magnetically activated switch.

18. The method of claim 11, the user having a thumb and an index finger, the method further including:
in (b), the user using the thumb and the index finger to move said activation magnet to said energized position.
